(19) United States
(12) Patent Application Publication
(10) Pub. No.: US 2017/0119503 A1
(43) Pub. Date: May 4, 2017

(54) SPIKE-FIXING TYPE IMPLANT AND METHOD FOR IMPLANTING SAME

(71) Applicant: Rae Hoe KIM, Daejeon (KR)

(72) Inventor: Rae Hoe KIM, Daejeon (KR)

(21) Appl. No.: 15/115,257

(22) PCT Filed: Sep. 11, 2014
(86) PCT No.: PCT/KR2014/008476

§ 371 Date: Jul. 28, 2016

(30) Foreign Application Priority Data
Nov. 6, 2013 (KR) 10-2013-0134052

(51) Int. Cl. A61C 8/00

(52) U.S. Cl. CPC A61C 8/0033; A61C 8/0039; A61C 8/0054; A61C 8/0074

(57) ABSTRACT

The present invention relates to a spike-fixing type implant and a method for implanting the same, the method enabling a dental root support to be inserted into the inside of an implant body in a state where the implant body, having a plurality of spikes protrusively formed thereon, is inserted in a dental root groove such that the diameter of the implant body is enlarged, and thus the spikes formed on the implant body are embedded in an alveolar bone and, finally, the implant body is firmly fixed in the dental root groove.

### TECHNICAL FIELD

The present invention relates to a spike-fixing type implant and a method for implanting the same, and more particularly, to a spike-fixing type implant and a method for implanting the same, which enable a dental root support to be inserted into the inside of an implant body in a state where the implant body, having a plurality of spikes protrusively formed thereon, is inserted in a dental root groove, such that the diameter of the implant body is enlarged, and thus the spikes formed on the implant body are embedded in an alveolar bone and, finally, the implant body is firmly fixed in the dental root groove.

### BACKGROUND ART

An implant refers to a replacement which can recover a lost body tissue, and in the dental care field, refers to a replacement which recovers teeth's original functions on behalf of a dental root of a lost tooth.

The implant inserted into a place where a tooth is lost to serve as a tooth has been developed to have various shapes and used, and in recent years, an integrated type implant of a screw form (Utility Model Application No. 20011-002490) is widely used.

Such a related-art integrated type implant has a bolt shape and thus a dental procedure is performed in the same way as the bolt is inserted into a dental root groove.

In this case, a screw is wider than the outer diameter of the dental root groove, and thus is fixed to the inner wall surface of the dental root groove.

As the depth of the screw increases, the screw is fixed better. However, when the implant is implanted, there may various side effects, such as a broken alveolar bone or necrosis of gum tissue which may be caused by poor blood circulation due to the blockage of blood flow by the screw. Therefore, there is a difficulty in overcoming the problems of the related-art method.

Therefore, there is a problem that there is no choice but to adopt a method which requires 3-6 months to complete osseointegration after implanting.

### DETAILED DESCRIPTION OF THE PRESENT DISCLOSURE

### Technical Object

The present invention has been developed in order to solve the above-mentioned problems, and a first object of the present invention is to provide a spike-fixing type implant and a method for implanting the same, which enable a dental root support to be inserted into the inside of an implant body in a state where the implant body is inserted in a dental root groove such that the diameter of the implant body is enlarged, and thus spikes formed on the implant body are embedded in an alveolar bone and, finally, the implant body is firmly fixed in the dental root groove.

A second object of the present invention is to provide a spike-fixing type implant and a method for implanting the same, which enables spikes to be embedded in an alveolar bone in a state where an implant body is inserted into a dental root groove, so that various side effects, such as a broken alveolar bone or necrosis of gum tissue which may be caused by poor blood circulation due to the blockage of blood flow by a screw, can be prevented.

A third object of the present invention is to provide a spike-fixing type implant and a method for implanting the same, wherein an implant body adheres to a dental root groove by means of a screw thread and spikes, and a dental root support is sealed in the implant body by a seal ring and screwing, so that bacterial penetration or inflow of foreign substances can be prevented.

### Technical Solving Method

According to an exemplary embodiment of the present invention to solve the above-mentioned problems, a first invention relates to a spike-fixing type implant, is characterized of including: an implant body configured to have a cylindrical shape and have a contracted diameter selectively enlarged by an external force, and have a plurality of spikes protrusively formed on the outer circumference thereof; and a dental root support which is inserted into the inside of the implant body in a state where the implant body is inserted into a dental root groove, and thus enlarges the diameter of the implant body, such that the implant body is fixed to an alveolar bone by means of the spikes.

A second invention is characterized in that, in the first invention, the implant body includes an exposure portion which is exposed to the outside of a gum, and an insertion portion which is inserted into the inside of the dental root groove.

A third invention is characterized in that, in the second invention, the insertion portion is split through a plurality of cut portions, and thus has a diameter contracted to be relatively smaller than that of the exposure portion, and has the plurality of spikes protrusively formed on the outer circumference thereof.

A fourth invention is characterized in that, in the second invention, a screw thread is partially formed on an outer circumference of an upper portion of the insertion portion, thereby allowing the implant body to be implanted into the dental root groove.

A fifth invention is characterized in that, in first invention, the dental root support includes a head portion which is connected with a center of an artificial tooth, and a rod portion which downwardly extends from the head portion to be inserted into the inside of the implant body and enlarge the insertion portion.

A sixth invention is characterized in that, in the fifth invention, a male screw thread is further formed on an outer circumference of an upper portion of the rod portion to be screwed into the implant body, and a close contact taper surface is further formed between the head portion and the rod portion to be brought into close contact with a seating taper surface formed on the exposure portion of the implant body.

A seventh invention is characterized in that, in the second invention, a seal ring is inserted into the upper end of the exposure portion to seal by pressure of the head portion and prevent bacterial penetration.

According to an exemplary embodiment of the present invention to solve the above-mentioned problems, an eighth invention relates to a method for implanting of a spike-fixing type implant, and characterized of including: forming a dental root groove on a location where an implanting operation is to be performed (S100); implanting an implant body by inserting and fixing the implant body in the dental root groove (S200); inserting a dental root support into the implant body such that an insertion portion of the implant body is enlarged inside the dental root groove and thus spikes are embedded in an alveolar bone and fixed (S300); fixing the dental root support to the implant body by screwing a male screw thread formed on a rod portion into a female screw thread formed on the implant body by rotating the dental root support (S400); and bonding an artificial tooth by coating edges of a head portion of the dental root support and an exposure portion of the implant body with an adhesive (S500).

### Advantageous Effect

According to the spike-fixing type implant and the method for implanting the same according to the present invention, a connection section between the screw thread and the dental root groove is minimized, so that various side effects which may occur when the implant is implanted into the dental root groove, such as a broken alveolar bone or necrosis of gum tissue which may be caused by poor blood circulation due to the blockage of blood flow by a screw, can be prevented.

In addition, the implant body is enlarged by the dental root support and the spikes are embedded and fixed in the alveolar bone, so that a dental procedure can be performed for a patient with a slow rate of osseointegration, and less time is required to complete osseointegration after implanting.

In addition, a space with the dental root groove is minimized through the implant body having the diameter enlarged, so that germs can be prevented from living.

In addition, the implant body adheres to the dental root groove by means of the screw thread and spikes, and the dental root support is sealed in the implant body by the seal ring and screwing, so that bacterial penetration or inflow of foreign substances can be prevented.

### BRIEF DESCRIPTION OF THE DRAWINGS

FIG. 1 is a perspective view of a spike-fixing type implant according to the present invention;

FIG. 2 is a cross section view showing a dental root support which is connected to the implant body of FIG. 1;

FIG. 3 is a perspective view showing the implant body, the dental root support, and an artificial tooth which are connected with one another according to the present invention;

FIG. 4 is a sequence diagram showing steps of the spike-fixing type implant according to the present invention; and

FIGS. 5 and 9 are views showing implanting at each step according to the sequence diagram of FIG. 4.

### BEST MODE FOR EMBODYING THE INVENTION

### Mode for Embodying the Invention

Hereinafter, a spike-fixing type implant according to the present invention will be described in detail with reference to the accompanying drawings.

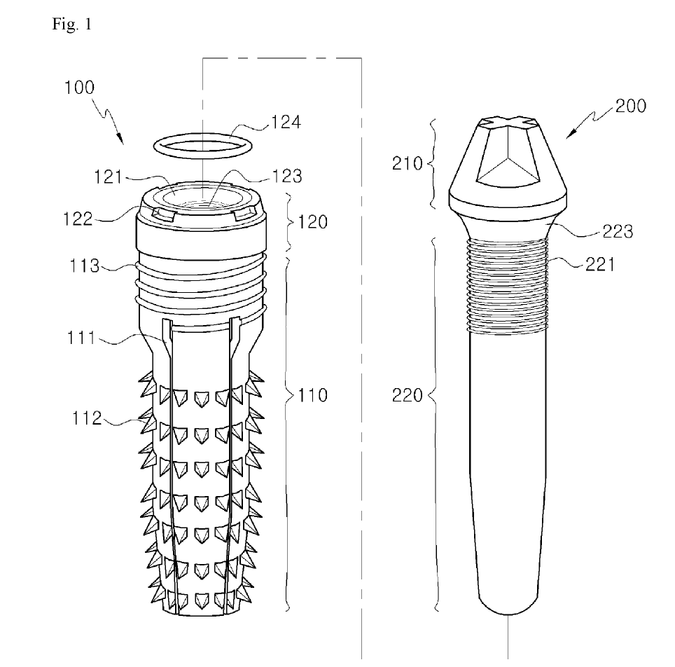

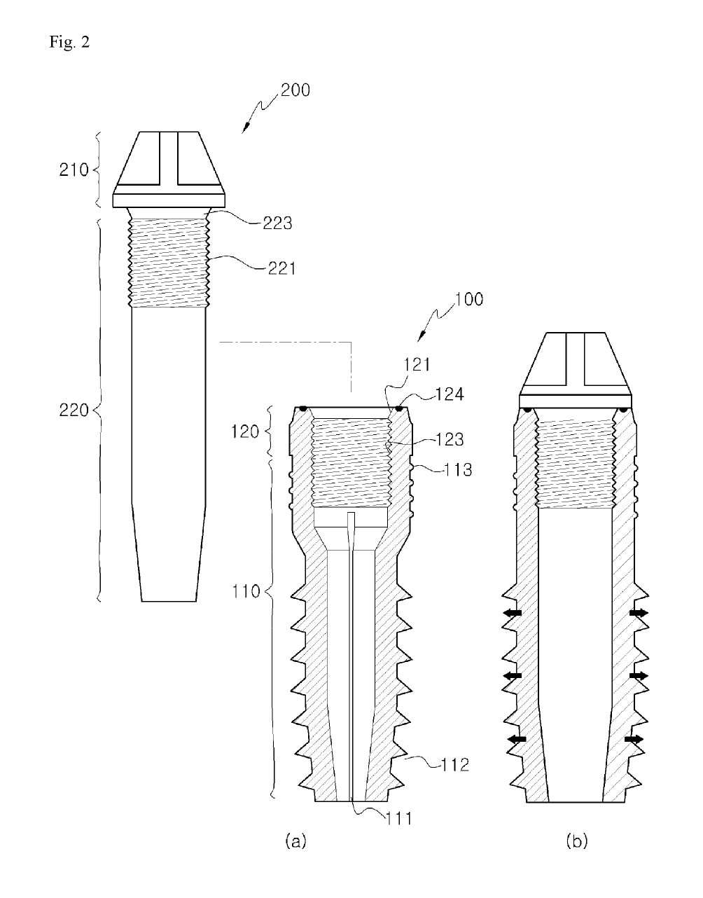

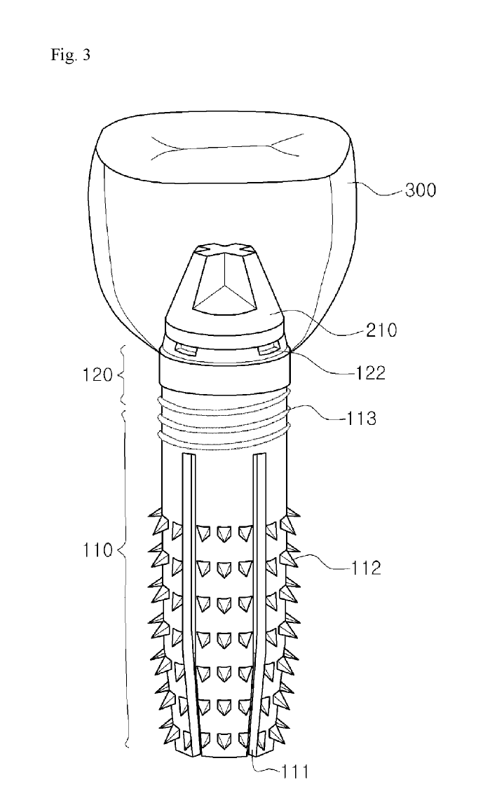

FIG. 1 is a perspective view showing a spike-fixing type implant according to the present invention, FIG. 2 is a cross section showing a dental root support which is connected to the implant body of FIG. 1, and FIG. 3 is a perspective view showing the implant body, the dental root support, and an artificial tooth which are connected with one another according to the present invention.

As shown in FIGS. 1 to 3, the present invention relates to a spike-fixing type implant, which is configured to have a dental root support 200 inserted into the inside of an implant body 100 in a state where the implant body 100, having a plurality of spikes 112 protrusively formed thereon, is inserted into a dental root groove 400, such that the diameter of the implant body 100 is enlarged, and thus the implant body 100 is firmly fixed to an alveolar bone by means of the spikes 112.

The spike-fixing type implant described above is normally divided into two parts, that is, the implant body 100 and the dental root support 200.

The implant body 100 has a cylindrical shape and is configured to enlarge the diameter which has been contracted by an external force, and has a plurality of spikes 112 protrusively formed on the outer circumference thereof.

Herein, the spike 112 may be formed in any one shape of a cone, a triangular pyramid, and a quadrangular pyramid having a solid shape like a wedge. In addition, the spike 112 may be formed in other shapes such as a protrusion pin.

The implant body 100 formed as described above includes an exposure portion 120 which is exposed to the outside of a gum, and an insertion portion 110 which is inserted into the inside of the dental root groove 400.

In this case, the insertion portion 110 is split through a plurality of cut portions 111 such that the diameter is contracted to be relatively smaller than that of the exposure portion 120, and has the plurality of spikes 112 protrusively formed on the outer circumference thereof.

According to this configuration of the contracted insertion portion 110, when the diameter of the insertion portion 110 is enlarged in a state in which the implant body 100 is inserted into the dental root groove 400, the spikes 112 are embedded in the alveolar bone and thus the implant body 100 is fixed to the dental root groove 400.

The exposure portion 120 is configured to have a plurality of recesses 122 formed on the upper portion thereof to be connected with a separate rotating means and transmit a rotational force.

In addition, the insertion portion 110 has a screw thread 113 partially formed on the outer circumference of the upper portion thereof. By forcedly rotating the implant body 100 through a rotating means, the screw thread 113 forcedly enters the dental root groove 400 and is fixed, and accordingly, the implant body 100 can be implanted in the dental root groove 400 without being shaken.

The dental root support 200 is inserted into the inside of the implant body 100 and functions to enlarge the diameter of the implant body 100, such that the implant body 100 is fixed to the alveolar bone in the state where the implant body 100 is inserted into the dental root groove 400.

The above-described dental root support 200 includes a head portion 210 which is connected to the center of an artificial tooth 300, and a rod portion 220 which downwardly extends from the head portion 210 to be inserted into the inside of the implant body 100 and enlarge the insertion portion 110.

The rod portion 220 further includes a male screw thread 221 formed on the outer circumference of the upper portion thereof to be screwed into a female screw thread 123 formed on the inner circumference of the implant body 100.

This configuration enables the dental root support 200 to be fixed to the implant body 100 without being separated from the implant body 100, and also provides an additional effect of preventing bacterial penetration by screwing the dental root support 200 and the implant body 100 to each other.

In addition, the head portion 210 has an upper end formed in a crisscross shape, and thus can easily forward a rotational force. A close contact area may be enlarged through the head portion 210 formed in the crisscross shape, so that adhesion to the artificial tooth 300 can be firmly achieved.

According to the configuration of the above-described dental root support 200, when the rod portion 220 is inserted into the insertion portion 110 of the implant body 100 as shown in FIGS. 2 and 3B, the insertion portion 110 which has been contracted is enlarged as much as the diameter of the exposure portion 120, and thus the spikes 112 are embedded in the alveolar bone without damaging the alveolar bone, and as a result, the implant body 100 is fixed in the dental root groove 400.

In addition, the insertion portion 110 of the implant body 100 is enlarged, such that a space between the implant body 100 and the dental root groove 400 is removed and thus there is an additional effect of preventing germs from living.

In addition, a close contact taper surface 230 may further be provided between the head portion 210 and the rod portion 220 to be brought into close contact with a seating taper surface 121 formed on the exposure portion 120 of the implant body 100.

Such a taper close contact structure can increase air tightness between the head portion 210 and the rod portion 220, and thus can prevent germs or other foreign substances from entering.

In addition, a seal ring 124 is connected with the upper end of the exposure portion 120 of the implant body 100 to be compressed by pressure of the head portion 210.

Herein, the seal ring 124 may perform a function of preventing damages to the exposure portion 120 and the head portion 210 by offsetting a fastening impact between the exposure portion 120 of the implant body 100 and the head portion 210 of the dental root support 200, as well as a sealing function, and also, perform a function of preventing damages to the male screw thread 221 and the female screw thread 123, which may be caused by excessive securing of the dental root support 200.

In addition, as shown in FIG. 3, the artificial tooth 300 is integrally bonded and fixed around the head portion 210 of the dental root support 200 and the exposure portion 120 of the implant body 100 through an adhesive.

Hereinafter, a method for implanting a spike-fixing type implant according to the present invention will be described in detail with reference to the accompanying drawings.

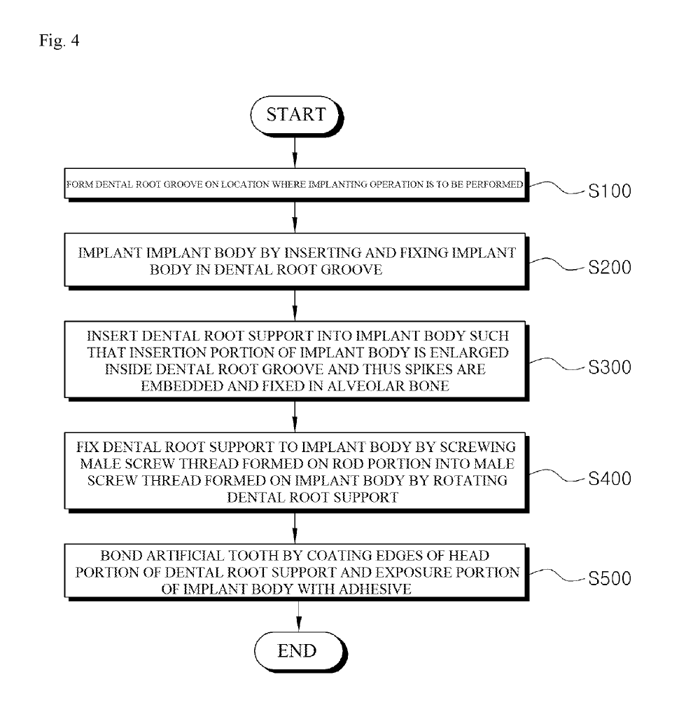

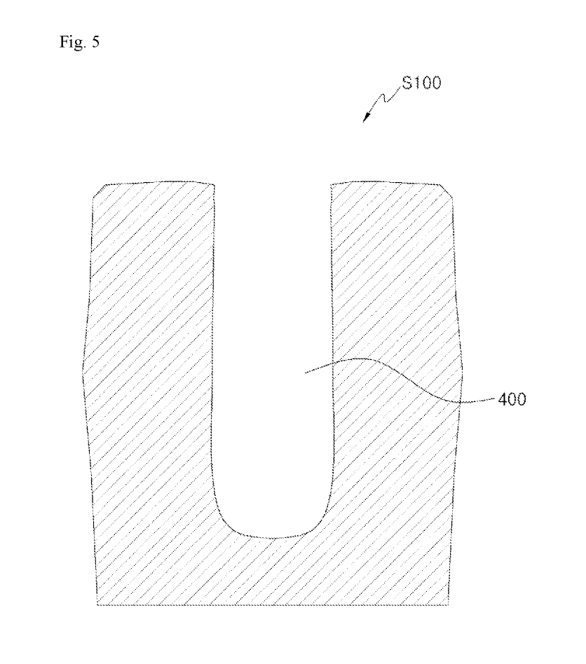

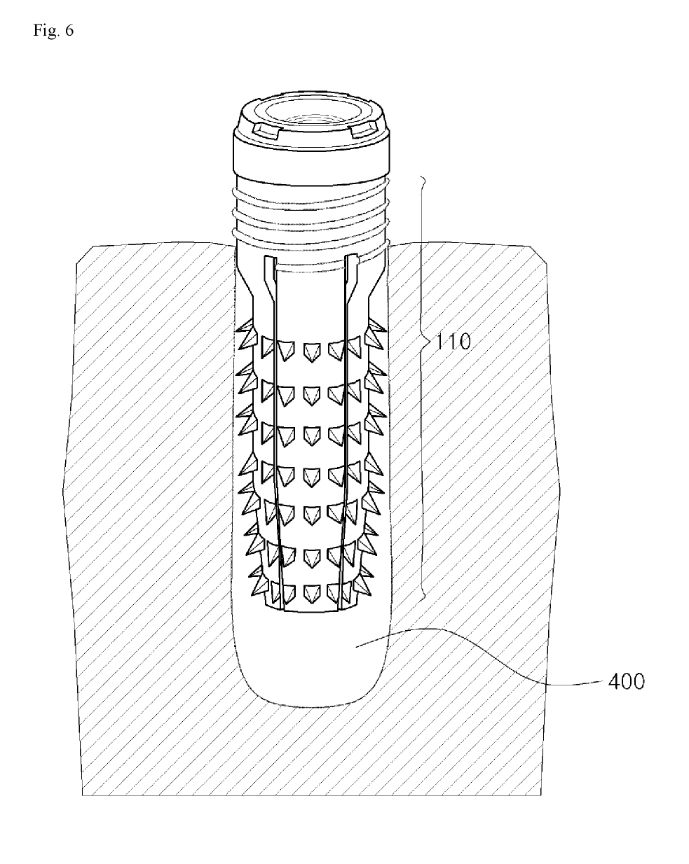

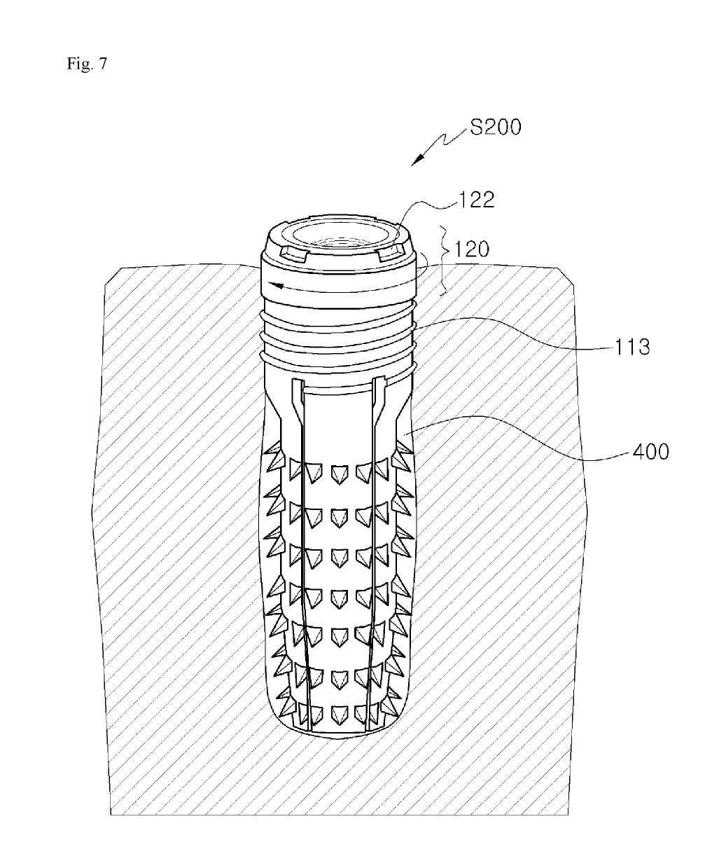

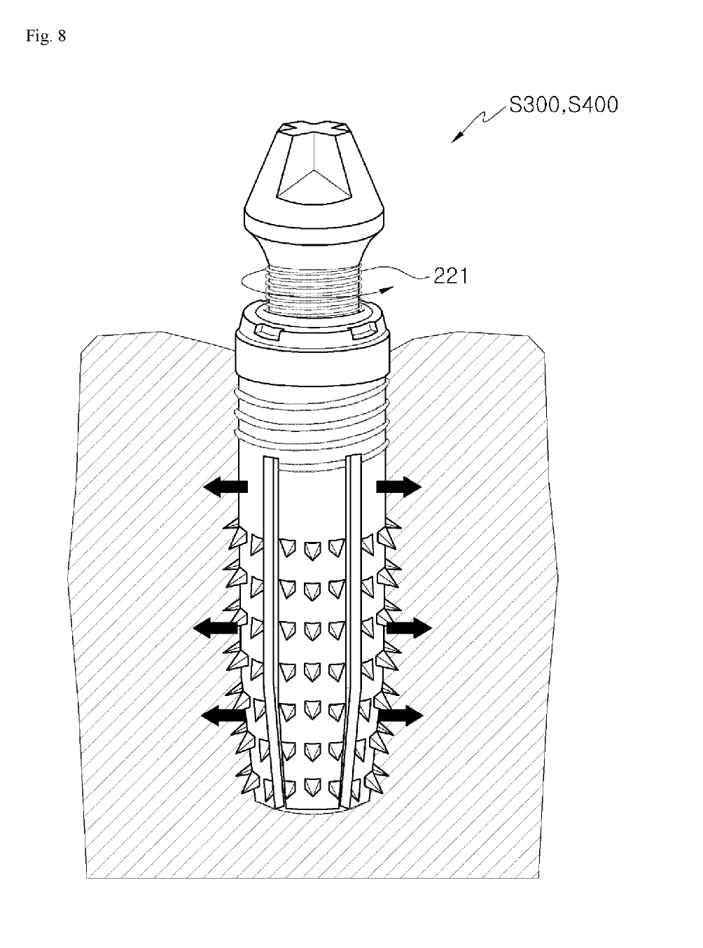

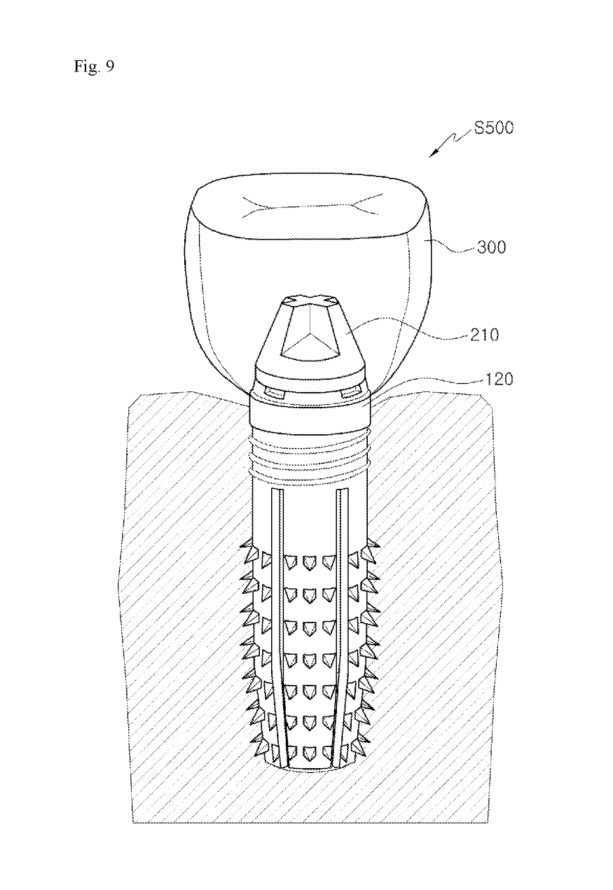

FIG. 4 is a sequence diagram showing steps of the spike-fixing type implant according to the present invention, and FIGS. 5 and 9 are views showing implanting at each step according to the sequence diagram of FIG. 4.

As shown in FIG. 5, a location where the implant body 100 is to be installed is grasped and the dental root groove 400 is formed using a drill (not shown) (S100).

In this time, prior to performing this step, the inner diameter of the dental root groove 400 should be formed to be smaller than the diameter of the exposure portion 120 of the implant body 100 and greater than the insertion portion 110 of the implant body 100.

As shown in FIGS. 6 and 7, the insertion portion 110 of the implant body 100 is inserted into the dental root groove 400, and in this state, the implant body 100 is implanted in the dental root groove 400 through the screw thread 113 by forcedly rotating the exposure portion 120 in a fixed state using a rotating means (S200).

In addition, the rod portion 220 of the dental root support 200 is inserted into the inside of the implant body 100 such that the diameter of the insertion portion 110 of the implant body 100 which has been contracted is enlarged inside the dental root groove 400, as shown in FIG. 8 (S300).

In this case, when the rod portion 220 of the dental root support 200 is inserted into the implant body 100, the diameter of the insert portion 110 is enlarged, and thus the plurality of spikes 112 formed on the insertion portion 110 are embedded and fixed in the alveolar bone.

In addition, the dental root support 200 is integrally fixed to the implant body 100 by rotating the dental root support 200 and thus screwing the male screw thread formed on the rod portion 220 into the male screw thread 123 formed on the implant body 100 (S400).

Finally, the artificial tooth 300 is bonded by coating the edges of the head portion 210 of the dental root support 200 and the exposure portion 120 of the implant body 100 with an adhesive, and the implanting is completed as shown in FIG. 9 (S500).

What is claimed is:

1. A spike-fixing type implant comprising:
an implant body configured to have a cylindrical shape and have a contracted diameter selectively enlarged by an external force, and have a plurality of spikes protrusively formed on the outer circumference thereof; and
a dental root support which is inserted into the inside of the implant body in a state where the implant body is inserted into a dental root groove, and thus enlarges the diameter of the implant body, such that the implant body is fixed to an alveolar bone by means of the spikes.

2. The spike-fixing type implant of claim 1, wherein the implant body comprises an exposure portion which is exposed to the outside of a gum, and an insertion portion which is inserted into the inside of the dental root groove.

3. The spike-fixing type implant of claim 2, wherein the insertion portion is split through a plurality of cut portions, and thus has a diameter contracted to be relatively smaller than that of the exposure portion, and has the plurality of spikes protrusively formed on the outer circumference thereof.

4. The spike-fixing type implant of claim 2, wherein a screw thread is partially formed on an outer circumference of an upper portion of the insertion portion, thereby allowing the implant body to be implanted into the dental root groove.

5. The spike-fixing type implant of claim 1, wherein the dental root support comprises a head portion which is connected with a center of an artificial tooth, and a rod portion which downwardly extends from the head portion to be inserted into the inside of the implant body and enlarge the insertion portion.

6. The spike-fixing type implant of claim 5, wherein a male screw thread is further formed on an outer circumference of an upper portion of the rod portion to be screwed into the implant body, and a close contact taper surface is further formed between the head portion and the rod portion to be brought into close contact with a seating taper surface formed on the exposure portion of the implant body.

7. The spike-fixing type implant of claim 2, wherein a seal ring is inserted into the upper end of the exposure portion to seal by pressure of the head portion and prevent bacterial penetration.

8. A method for implanting of a spike-fixing type implant, the method comprising:
forming a dental root groove on a location where an implanting operation is to be performed (S100);
implanting an implant body by inserting and fixing the implant body in the dental root groove (S200);
inserting a dental root support into the implant body such that an insertion portion of the implant body is enlarged inside the dental root groove and thus spikes are embedded in an alveolar bone and fixed (S300);
fixing the dental root support to the implant body by screwing a male screw thread formed on a rod portion into a female screw thread formed on the implant body by rotating the dental root support (S400); and
bonding an artificial tooth by coating edges of a head portion of the dental root support and an exposure portion of the implant body with an adhesive (S500).
